(19) United States
(12) Patent Application Publication
(10) Pub. No.: US 2026/0208329 A1
(43) Pub. Date: Jul. 23, 2026

(54) CONNECTION ROD TOOL WITH AUXILIARY DEVICE

(71) Applicant: TSE-MING LIN, TAICHUNG CITY (TW)

(72) Inventor: TSE-MING LIN, TAICHUNG CITY (TW)

(21) Appl. No.: 19/027,596

(22) Filed: Jan. 17, 2025

(51) Int. Cl. B25B 23/00; B25B 23/16

(52) U.S. Cl. CPC B25B 23/0021; B25B 23/16

(57) ABSTRACT

A connection rod tool with auxiliary device includes a connection rod and an auxiliary device. The connection rod has a connecting end and an opposite driving end disposed along an axis, with a rod part extending therebetween along the axis. The auxiliary device has a combination part and a handgrip part for easy gripping. The combination part is disposed on the rod part and allowed to be freely movable thereon along the axis. Thus, the user is able to grip the auxiliary device during operation without the necessity of directly contacting the rod part, thereby preventing injury caused by high temperature due to friction.

### BACKGROUND OF THE DISCLOSURE

### 1. Field of the Disclosure

The present disclosure relates to tools, and more particularly, to a connection rod tool with auxiliary device.

### 2. Description of the Related Art

In the installation of light steel frames or ceilings, bolts are usually located at relatively higher positions, so that a worker needs to use a connection rod having a certain length to reach the bolts and perform fastening or loosening operations through a power tool. Generally, a connection rod mainly has three parts, including the connecting end for engaging with the bolt, the driving end connected to the power tool, and the rod part located between the connecting end and the driving end.

During operation, the worker needs to hold the rod part with one hand and operate the power tool with the other hand. Due to the high-speed rotation of the power tool, contact between the hand and the rod part easily generates a high temperature caused by friction, which might lead to potential injuries. Also, a long rod part may cause axial deflection during use, especially when the rod length is longer, causing a more significant operational deflection.

### SUMMARY OF THE DISCLOSURE

The present disclosure aims at providing a connection rod tool with auxiliary device. By holding the auxiliary device, the user does not need to contact the rod part with bare hand, so as to prevent injuries caused by high temperature due to friction during operation.

For achieving the aforementioned objectives, the present disclosure provides a connection rod tool with auxiliary device, comprising:

a connection rod having a connecting end and an opposite driving end disposed along an axis, with a rod part extending between the connecting end and the driving end along the axis; and

an auxiliary device having a combination part and a handgrip part for easy gripping, the combination part being disposed on the rod part and freely movable thereon along the axis.

With such configuration, the present disclosure provides the auxiliary device to be held by the hand of the user, so that the hand of the user is prevented from directly contacting the rod part of the connection rod, so as to avoid the injuries caused by high temperature due to friction during operation. In addition, the auxiliary device provides a supporting function for the hand of the user, so as to effectively reduce the axial deflection of the rod part of the connection rod during operation, thereby further improving the stability and accuracy of operation.

In another embodiment of the present disclosure, the auxiliary device comprises a cylinder member and an extension member, with a combination part disposed on the inner edge of the cylinder member. The combination part is a sliding bore, which is slidably disposed on the rod part. The extension member has one end disposed on the cylinder member and the other end provided with a handgrip part. With the telescopic adjustment function of the extension member, the auxiliary device is applicable to connection rods having different lengths or fulfill different operational conditions.

### BRIEF DESCRIPTION OF THE DRAWINGS

FIG. 1 is a perspective view of the connection rod tool with auxiliary device in accordance with the first embodiment of the present disclosure.

FIG. 2 is a cross-sectional view taken along line 2-2 in FIG. 1.

FIG. 3 is a schematic view illustrating the operation status of the connection rod tool with auxiliary device in accordance with the first embodiment of the present disclosure.

FIG. 4 is a perspective view of the connection rod tool with auxiliary device in accordance with the second embodiment of the present disclosure.

FIG. 5 is a cross-sectional view taken along line 5-5 in FIG. 1.

FIG. 6 is a schematic view illustrating the adjustment operation of the cylinder member and the extension member in accordance with the second embodiment of the present disclosure.

FIG. 7 is a schematic view illustrating the operation status of the connection rod tool with auxiliary device in accordance with the second embodiment of the present disclosure

### DETAILED DESCRIPTION OF THE DISCLOSURE

The aforementioned and further advantages and features of the present disclosure will be understood by reference to the description of the preferred embodiment in conjunction with the accompanying drawings where the components are illustrated based on a proportion for explanation but not subject to the actual component proportion. Embodiments of the present disclosure are illustrated in detail along with the drawings. However, the technical features included by the present disclosure are not limited to certain embodiments hereby provided. Scope of the present disclosure shall be referred to the claims, which include all the possible replacements, modifications, and equivalent features.

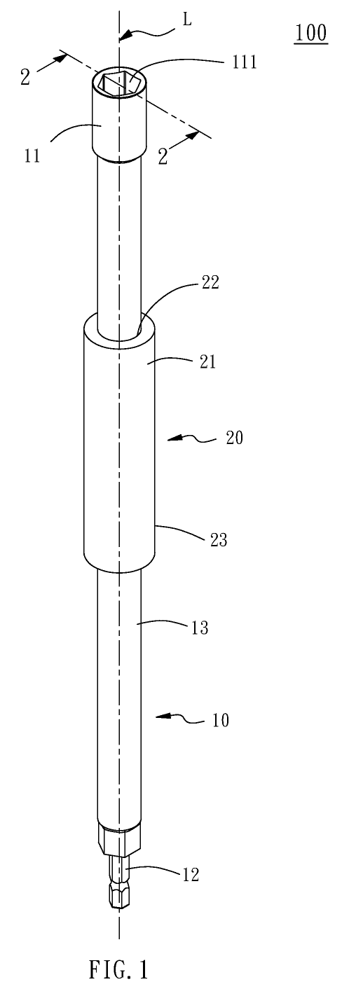

Referring to FIG. 1 to FIG. 3, the present disclosure provides a connection rod tool 100 with auxiliary device, comprising a connection rod 10 and an auxiliary device 20.

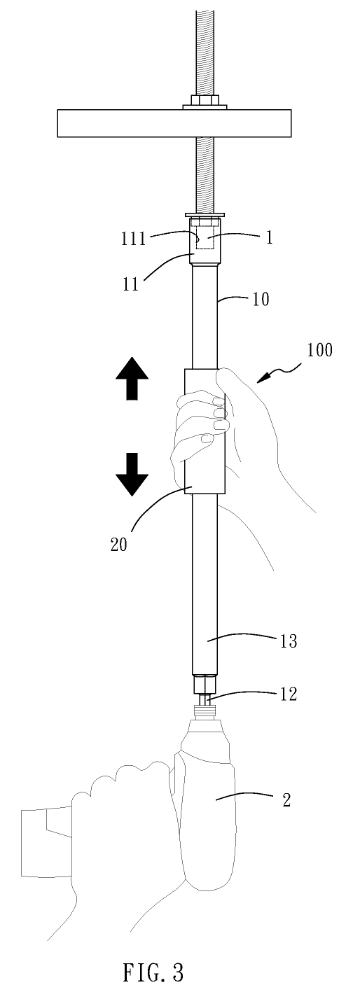

The connection rod 10 is formed of a metal material. The connection rod 10 has a connecting end 11 and an opposite driving end 12 disposed along an axis L, with a rod part 13 extending between the connecting end 11 and the driving end 12 along the axis L. The connecting end 11 comprises a non-circular connecting hole 111 to be screwedly combined with a screw member 1, as shown by FIG. 3. The driving end 12 is formed in a polygonal shape. The rod part 13 is hollow. The driving end 12 is allowed to be formed in a tetragonal or hexagonal shape, so as to be accordingly connected with and driven by a power tool 2. Based on the fact that the rod part 13 has a certain length, the connection rod 10 is applicable to the screwing operation of a deeper hole or at a higher position, such as a light steel frame or ceiling related construction.

In the first embodiment, the auxiliary device 20 comprises a cylinder member 21. The cylinder member 21 has a combination part 22 disposed on an inner edge thereof and a handgrip part 23 on an outer edge thereof for easy gripping. The handgrip part 23 is formed in a shape with a certain thickness, such as a cylindrical shape, to facilitate gripping. Therein, the combination part 22 is a sliding bore slidably disposed on the rod part 13. The auxiliary device 20 is formed of a plastic material. Accordingly, the combination part 22 is disposed on the rod part 13 and freely movable thereon along the axis L. In another embodiment, the auxiliary device 20 comprises a clamp, which is positioned at any heights on the rod part 13 in a clamping manner, thereby achieving the same effect as previously described.

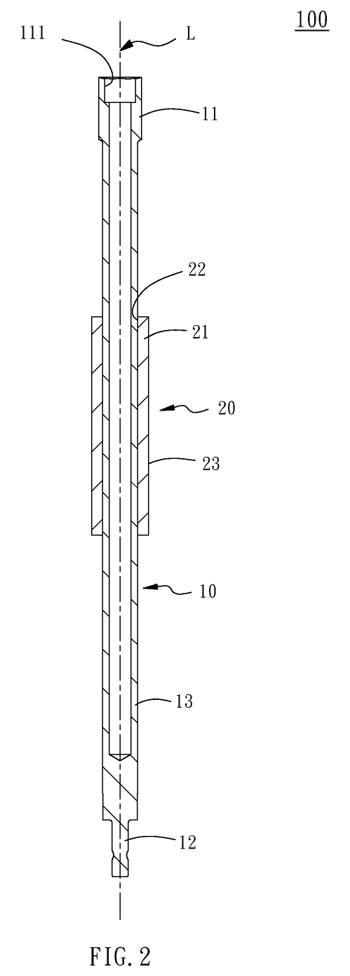

Referring to FIG. 3 in view of FIG. 2, the user grips the auxiliary device 20 and indirectly holds the rod part 13 with one hand and operates the power tool 2 with the other hand, so as to carry out the fastening operation. Because the cylinder member 21 of the auxiliary device 20 is mounted around the outer edge of the rod part 13 of the connection rod 10, the hand of the user does not directly contact the surrounding position of the rod part 13, effectively preventing hand injuries caused by high temperature due to rotational friction of the connection rod 10. Also, the auxiliary device 20 provides the hand with a stabilizing and supporting function, reducing the axial deflection of the rod part 13 during operation, thereby improving the operational precision and ensuring the completion of the fastening operation.

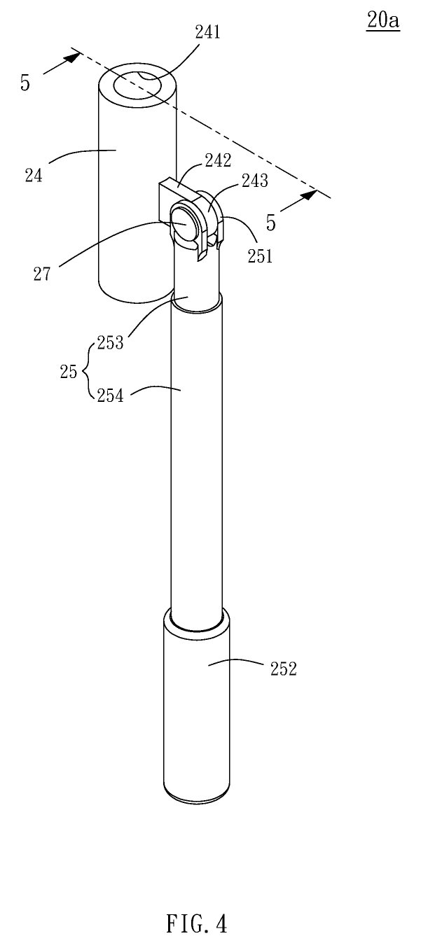

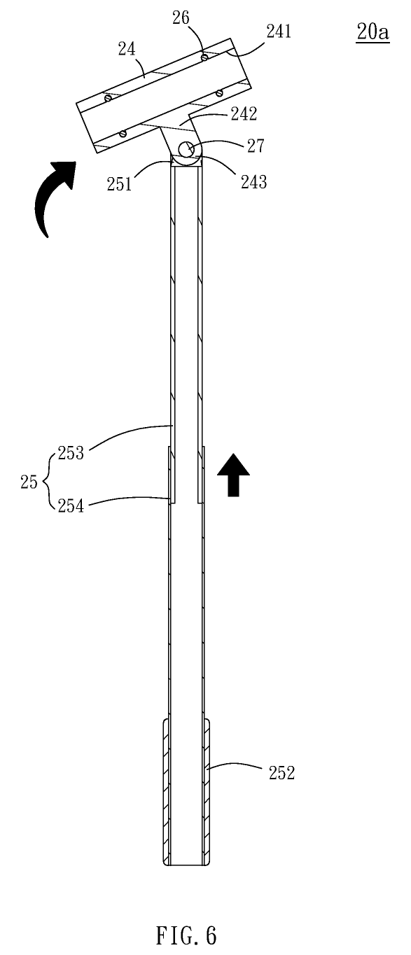

Referring to FIG. 4 to FIG. 7, the second embodiment of the connection rod tool 100 with auxiliary device of the present disclosure is provided. The difference between the second embodiment and the first embodiment lies in that an auxiliary device 20 a comprises a cylinder member 24 and an extension member 25. The cylinder member 24 comprises a combination part 241 disposed on an inner edge thereof. The combination part 241 is a sliding bore and slidably disposed on the rod part 13, with a plurality of contact beads 26 embedded in the sliding bore and contacting the rod part 13 in a rolling manner, facilitating the cylinder member 24 displacing along the rod part 13. A transverse rod 242 protrudes and extends from an outer edge of the cylinder member 24, with a first pivot part 243 disposed on an end part of the transverse rod 242.

The extension member 25 comprises a second pivot part 251 and a handgrip part 252 disposed away from the second pivot part 251. The handgrip part 252 is formed in a cylindrical or rod shape. The first pivot part 243 and the second pivot part 251 are pivotally combined through a shaft member 27 passing through the first pivot part 243 and the second pivot part 251, such that the first pivot part 243 and the second pivot part 251 pivotally rotate with respect to each other.

The extension member 25 comprises an inner tube 253 and an outer tube 254 mounted therearound. The second pivot part 251 is disposed on the inner tube 253. The handgrip part 252 is disposed on the outer tube 254. The outer tube 254 is allowed to extend and retract with respect to the inner tube 253, so as to extend the operational length of the auxiliary device 20a.

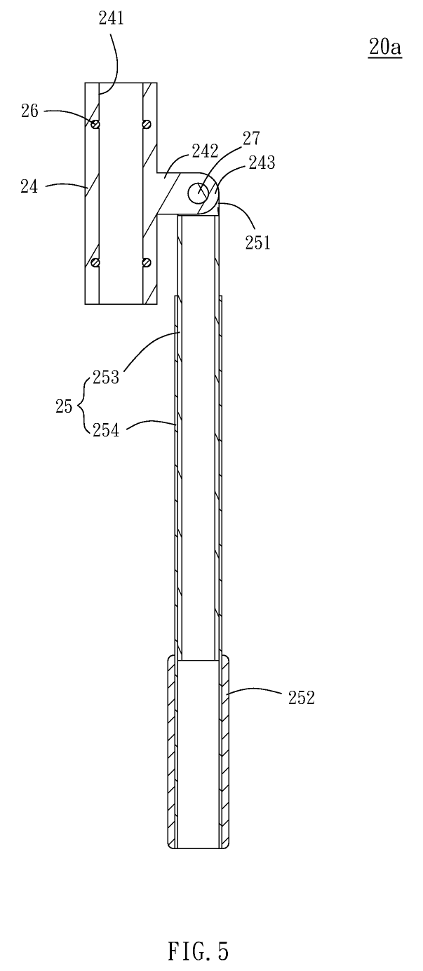

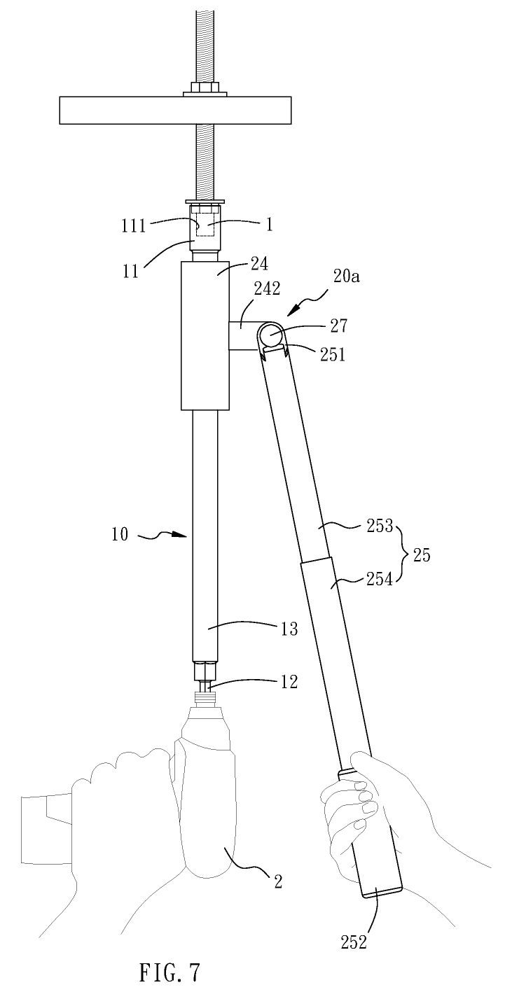

Referring to FIG. 7 in view of FIG. 5, the extension member 25 is pivotally disposed on the cylinder member 24, so that the extension member 25 generates a small angular adjustment with respect to the cylinder member 24 during operation, such that the user conveniently grips the handgrip part 252 and easily adjusts the axial height of the cylinder member 24 on the rod part 13 for fulfilling the height requirements in different operational conditions. In addition, due to the telescopic adjustment between the outer tube 254 and the inner tube 253 of the extension member 25, the auxiliary device 20 a can flexibly cooperate with the connection rod 10 of different lengths or meet the height requirements in different operational conditions. The extension member 25 is adjustable to have an appropriate length according to actual demands, not only facilitating the gripping operation, but also providing the hand of the user with stabilizing and supporting effect, thereby effectively preventing operational deflection issue of the rod part 13.

With the foregoing configuration, the present disclosure is structurally simple and conveniently operated. By gripping the auxiliary device 20, 20 a, the hand of user does not directly contact the rod part 13 of the connection rod 10, preventing injuries caused by high temperature due to friction during operation.

Further, the auxiliary device 20, 20 a also provides the hand of user with a supporting function, so as to effectively prevent axial deflection of the rod part 13 of the connection rod 10 during operation, thereby ensuring the operational precision.

Although particular embodiments of the disclosure have been described in detail for purposes of illustration, various modifications and enhancements may be made without departing from the spirit and scope of the disclosure. Accordingly, the disclosure is not to be limited except as by the appended claims.

What is claimed is:

1. A connection rod tool with auxiliary device, comprising:
a connection rod having a connecting end and an opposite driving end disposed along an axis, with a rod part extending between the connecting end and the driving end along the axis; and
an auxiliary device having a combination part and a handgrip part, the combination part being disposed on the rod part and freely movable thereon along the axis.

2. The connection rod tool with auxiliary device of claim 1, wherein the auxiliary device comprises a cylinder member, and the combination part is disposed on an inner edge of the cylinder member; the handgrip part is disposed on an outer edge of the cylinder member; the combination part is a sliding bore slidably disposed on the rod part.

3. The connection rod tool with auxiliary device of claim 2, wherein the auxiliary device is formed of a plastic material; the connection rod is formed of a metal material.

4. The connection rod tool with auxiliary device of claim 3, wherein the connecting end has a non-circular connecting hole; the driving end is formed in a polygonal shape; the rod part is hollow.

5. The connection rod tool with auxiliary device of claim 1, wherein the auxiliary device comprises a cylinder member and an extension member; the combination part is disposed on an inner edge of the cylinder member; the combination part is a sliding bore slidably disposed on the rod part; the extension member has one end pivotally disposed on the cylinder member, with the handgrip part disposed on another end of the extension member.

6. The connection rod tool with auxiliary device of claim 5, wherein a plurality of contact beads are embedded in the sliding bore for contacting the rod part in a rolling manner.

7. The connection rod tool with auxiliary device of claim 5, wherein a first pivot part is disposed on an outer edge of the cylinder member, and a second pivot part is disposed on the extension member and arranged away from the handgrip part; the first pivot part and the second pivot part are pivotally combined through a shaft member passing through the first pivot part and the second pivot part, such that the first pivot part and the second pivot part pivotally rotate with respect to each other.

8. The connection rod tool with auxiliary device of claim 7, wherein a transverse rod protrudes and extends from the outer edge of the cylinder member, with the first pivot part disposed on the transverse rod.

9. The connection rod tool with auxiliary device of claim 7, wherein the extension member comprises an inner tube and an outer tube mounted around the inner tube; the second pivot part is disposed on the inner tube, and the handgrip part is disposed on the outer tube; the outer tube extends and retracts with respect to the inner tube.

10. The connection rod tool with auxiliary device of claim 9, wherein the connecting end has a non-circular connecting hole; the driving end is formed in a polygonal shape; the rod part is hollow.
